(19) United States
(12) Patent Application Publication
(10) Pub. No.: US 2008/0137245 A1
(43) Pub. Date: Jun. 12, 2008

(54) SEMICONDUCTOR DEVICE

(75) Inventor: Takayuki Hiraoka, Kawasaki-shi (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignee: KABUSHIKI KAISHA TOSHIBA, Tokyo (JP)

(21) Appl. No.: 11/951,269

(22) Filed: Dec. 5, 2007

(30) Foreign Application Priority Data
Dec. 8, 2006 (JP) 2006-332153

(51) Int. Cl. H02H 9/04

(52) U.S. Cl. 361/56

(57) ABSTRACT

A semiconductor device is disclosed, which includes first, second and third power supply pads arranged in a peripheral area of a semiconductor chip, the second pad applied with a higher potential than the first pad, and the third pad applied with a higher potential than the second pad, first, second and third power supply wirings arranged in the peripheral area, the first wiring connected to the first pad, the second wiring connected to the second pad, and the third wiring connected to the third pad, a plurality of first electrostatic protection circuits arranged in the peripheral area and connected between the first and second wirings in correspondence to the first, second and third pads, and a plurality of second electrostatic protection circuits arranged in the peripheral area and connected between the second and third wirings in correspondence to the first, second and third pads.

### CROSS-REFERENCE TO RELATED APPLICATIONS

This application is based upon and claims the benefit of priority from prior Japanese Patent Application No. 2006-332153, filed Dec. 8, 2006, the entire contents of which are incorporated herein by reference.

### BACKGROUND OF THE INVENTION

1. Field of the Invention

The invention relates to a semiconductor device having electrostatic protection circuits to prevent electrostatic surge currents from flowing into a semiconductor chip equipped with a plurality of power supply terminals and wirings to which different power supplies of different voltages are applied, which is used with logic LSIs by way of example.

2. Description of the Related Art

A semiconductor chip of a multi-power-supply semiconductor device which has a number of power supply terminals and power supply wirings to which different power supply voltages are applied is required to ensure electrostatic protection for a number of power supplies. Conventionally, in order to suppress an electrostatic surge current, a leakage current in normal operation (at the time no discharge occurs) and the like, a separate electrostatic protection circuit is arranged for each of power supply pads (bonding pads) corresponding to two or more power supplies. In a case where separate electrostatic protection circuits corresponding to normal supply voltages have been set as hitherto, however, trying to form electrostatic protection circuits for the purpose of preventing electrostatic surge currents from flowing between power supplies of different voltages requires to freshly secure a separate area, which results in decreased area efficiency (packing efficiency).

In JP-A No. 2000-269432 (KOKAI), there is disclosed a technique to provide electrostatic protection for different power supplies of different voltages by using diode strings. In addition, JP-A No. 2005-191370 (KOKAI) discloses a technique of arranging the electrostatic protection devices in the peripheral area of a semiconductor chip, which are used to protect internal circuits arranged in the internal area of the semiconductor chip, to reduce the area required for the electrostatic protection devices.

### BRIEF SUMMARY OF THE INVENTION

According to a first aspect of the present invention, there is provided a semiconductor device comprising:

a first power supply pad which is arranged in a peripheral area of a semiconductor chip;

a second power supply pad which is arranged in the peripheral area of the semiconductor chip and applied in operation with a potential higher than a potential applied in operation to the first power supply pad;

a third power supply pad which is arranged in the peripheral area of the semiconductor chip and applied in operation with a potential higher than the potential applied in operation to the second power supply pad;

a first power supply wiring which is arranged in the peripheral area of the semiconductor chip and electrically connected to the first power supply pad;

a second power supply wiring which is arranged in the peripheral area of the semiconductor chip and electrically connected to the second power supply pad;

a third power supply wiring which is arranged in the peripheral area of the semiconductor chip and electrically connected to the third power supply pad;

a plurality of first electrostatic protection circuits which are arranged in the peripheral area of the semiconductor chip and connected between the first and second power supply wirings, the first electrostatic protection circuits being provided in correspondence to the first, second and third power supply pads in one-to-one relationship; and

a plurality of second electrostatic protection circuits which are arranged in the peripheral area of the semiconductor chip and connected between the second and third power supply wirings, the second electrostatic protection circuits being provided in correspondence to the first, second and third power supply pads in one-to-one relationship, and the second electrostatic protection circuits and the first electrostatic protection circuits forming electrostatic protection circuit series in correspondence to the first, second and third power supply pads in one-to-one relationship.

According to a second aspect of the present invention, there is provided a semiconductor device comprising:

a plurality of power supply pads which are arranged in a peripheral area of a semiconductor chip and applied with different power supply potentials in operation;

a plurality of power supply wirings which are arranged in the peripheral area of the semiconductor chip and electrically connected to the plurality of power supply pads, respectively; and

a plurality of electrostatic protection circuits which are arranged in the peripheral area of the semiconductor chip and connected between the plurality of power supply wirings, those of the plurality of electrostatic protection circuits, which are connected in series to each other and provided in correspondence to each of the plurality of power supply pads, forming an electrostatic protection circuit series.

According to a third aspect of the present invention, there is provided a semiconductor device comprising:

a semiconductor chip including an internal area and a peripheral area, at least an internal circuit to be protected from an electrostatic surge being formed in the internal area;

a plurality of power supply pads which are arranged in the peripheral area of the semiconductor chip and applied with different power supply potentials in operation;

a plurality of power supply wirings which are arranged in the peripheral area of the semiconductor chip and electrically connected to the plurality of power supply pads, respectively; and

a plurality of electrostatic protection circuits which are arranged in the peripheral area of the semiconductor chip and connected between the plurality of power supply wirings, those of the plurality of electrostatic protection circuits, which are connected in series to each other and provided in correspondence to each of the plurality of power supply pads, forming an electrostatic protection circuit series.

### BRIEF DESCRIPTION OF THE SEVERAL VIEWS OF THE DRAWING

FIG. 1 shows a plan view of a semiconductor chip;

FIG. 2 shows a portion of the arrangement of power supply pads and electrostatic protection circuits formed on a peripheral area of a semiconductor chip of a logic LSI which is a semiconductor device according to a first embodiment of the present invention;

FIG. 3 is a schematic plan view of a pattern layout in a peripheral area of the semiconductor chip of FIG. 2;

FIG. 4 is a detailed plan view of a portion of the layout shown in FIG. 3, and shows the arrangement of the power supply pads, the power supply wirings, and vias interconnecting the electrostatic protection circuits;

FIG. 5 illustrates a modification of the arrangement shown in FIG. 4, in which the power supply pads are arranged in a staggered form;

FIG. 6 shows an overall view of the arrangement of the power supply pads of a staggered form shown in FIG. 5;

FIG. 7 shows a portion of the arrangement of power supply pads and electrostatic protection circuits formed on a peripheral area of a semiconductor chip of a logic LSI which is a semiconductor device according to a second embodiment of the present invention; and

FIG. 8 shows an example of the circuit arrangement of the electrostatic protection circuits shown in FIG. 2.

### DETAILED DESCRIPTION OF THE INVENTION

The embodiments of the present invention will be described hereinafter with reference to the accompanying drawings, wherein like reference numerals are used to denote corresponding parts throughout the several views.

### FIRST EMBODIMENT

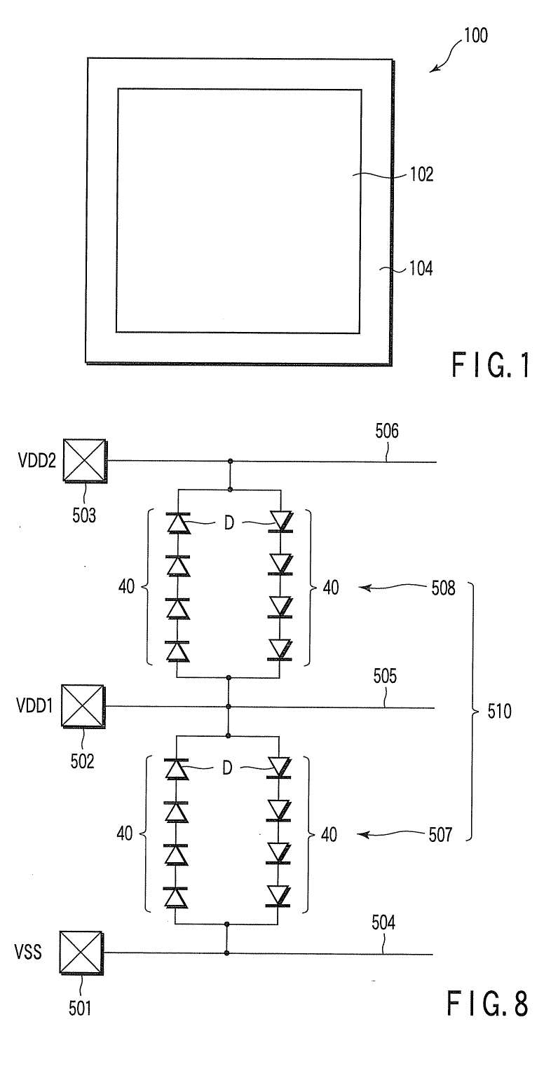

FIG. 1 shows a plan view of a semiconductor chip 100. In FIG. 1, 102 denotes an internal area of the semiconductor chip 100, in which a semiconductor circuit including an internal circuit is formed, and 103 denotes a peripheral area of the semiconductor chip 100, in which a power supply pad, a signal pad and the like are formed.

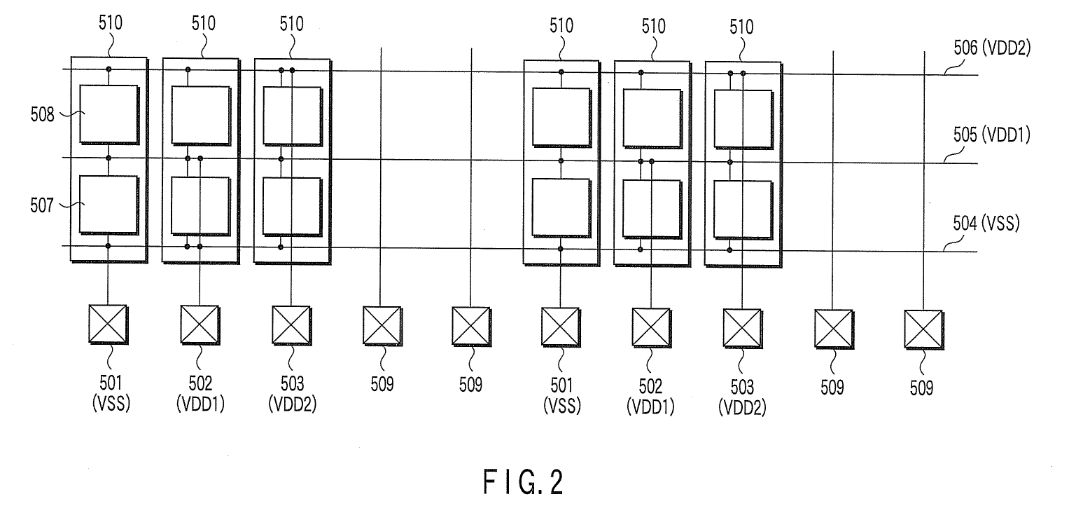

FIG. 2 shows a portion of the arrangement of power supply pads and electrostatic protection circuits formed on a peripheral area of a semiconductor chip of a logic LSI which is a semiconductor device according to a first embodiment of the present invention. In FIG. 2, reference numerals 501, 502 and 503 denote power supply pads. Reference numerals 504, 505 and 506 denote power supply wirings. Reference numeral 507 denotes first electrostatic protection circuits each of which is connected between the power supply wirings 504 and 505. Reference numeral 508 designates second electrostatic protection circuits each of which is connected between the power supply wirings 505 and 506. Reference numeral 509 designates signal pads. An arrangement of one first electrostatic protection circuit 507 and one second electrostatic protection circuit 508 connected in series forms an electrostatic protection circuit series 510. The electrostatic protection circuit series 510 are provided in correspondence to the power supply pads 501, 502 and 503, respectively.

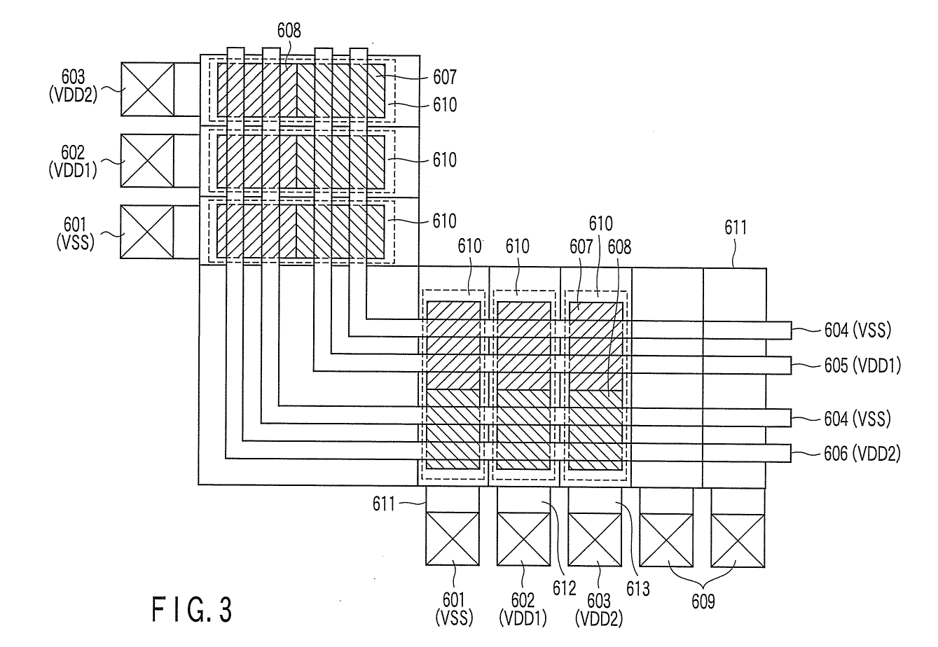

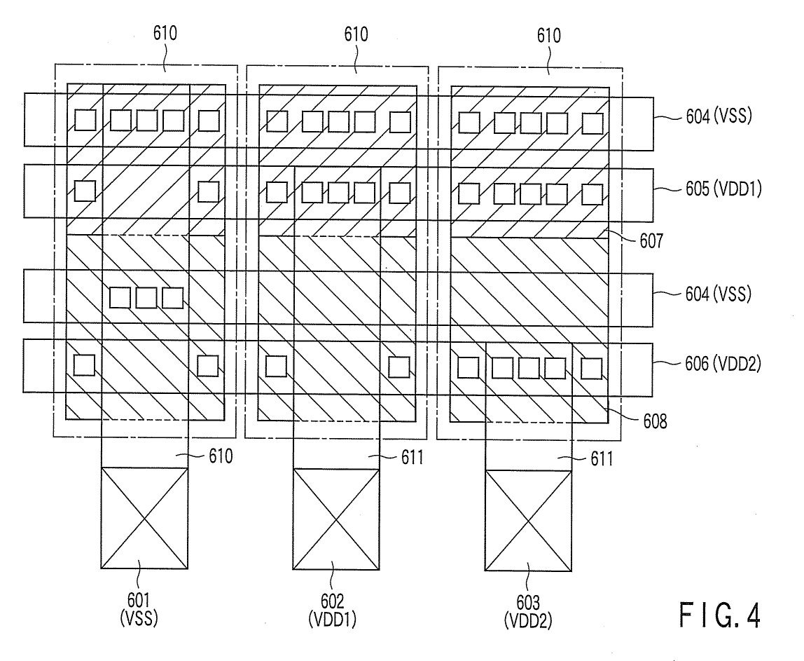

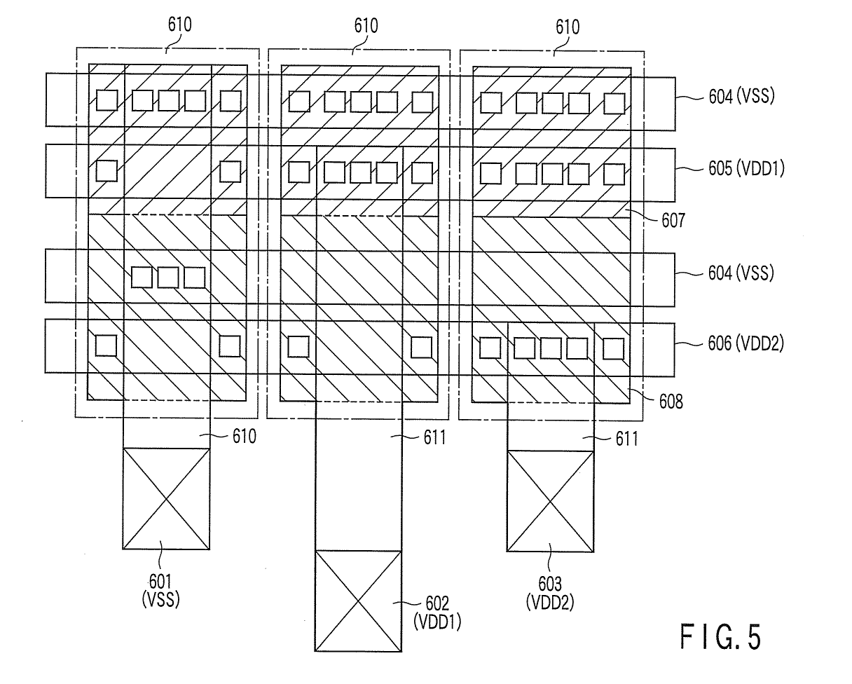

FIG. 3 is a schematic plan view of a pattern layout in the peripheral area of the semiconductor chip of FIG. 2. FIG. 4 is a detailed plan view of a portion of the layout shown in FIG. 3, and shows the arrangement of the power supply pads, the power supply wirings, and vias interconnecting the electrostatic protection circuits.

The power supply pads 501, 502 and 503 shown in FIG. 2 are denoted by reference numerals 601, 602 and 603, respectively, in FIGS. 3 and 4. The power supply wirings 504, 505 and 506 shown in FIG. 2 are denoted by reference numerals 604, 605 and 606, respectively, in FIGS. 3 and 4. The first and second electrostatic protection circuits 507 and 508 are denoted by reference numerals 607 and 608, respectively, in FIGS. 3 and 4. The signal pads 509 shown in FIG. 2 is denoted by reference numeral 609 in FIGS. 3 and 4. The electrostatic protection circuit series 510 shown in FIG. 2 is denoted by reference numeral 610 in FIGS. 3 and 4.

A semiconductor circuit (not shown) including internal circuits to be protected by the electrostatic protection circuits 507 and 508 is formed in the internal area of the semiconductor chip. The first and second electrostatic protection circuits 607 and 608 forming one electrostatic protection circuit series 610 are arranged adjacent to each other and formed on an under layer of the power supply wirings 604, 605 and 606 via an interlayered insulation film. The first and second electrostatic protection circuits 607 and 608 forming one electrostatic protection circuit series 610 are electrically connected in series to each other by means of connecting vias (i.e., in FIG. 4, the rightmost connecting vias and the leftmost connecting vias formed on the power supply wirings 604, 605 and 606).

The power supply pads 601, 602 and 603 are formed in a line, as shown in FIGS. 3 and 4. In the general view in FIG. 2, there are shown the power supply pads 501, 502 and 503, two each, formed in a line. The first, second and third power supply pads 601, 602 and 603 are externally applied in operation with three different power supply voltages VSS, VDD1 and VDD2, respectively. The power supply voltage VSS applied to the first power supply pad 601 is a reference potential (ground potential). The power supply voltage VDD1 applied to the second power supply pad 602 is a potential higher than VSS. The power supply voltage VDD2 applied to the third power supply pad 603 is a potential higher than VDD1.

The first, second and third power supply wirings 604, 605 and 606 corresponding to the power supply voltages VSS, VDD1 and VDD2, respectively, are routed over a wide area of the semiconductor chip so that the power supply wirings 604, 605 and 606 are connected to internal circuits formed in the internal area of the semiconductor chip, which are to be protected by the electrostatic protection circuits. The first power supply wirings 604 are electrically connected to the first power supply pad 601 through the power supply input wiring 611. Likewise, the second power supply wiring 605 is electrically connected to the second power supply pad 602 through the power supply input wirings 612, and the third power supply wiring 606 is electrically connected to the third power supply pad 603 through the power supply input wirings 613.

The electrostatic protection circuit areas 607 and 608 are positioned in the proximity of the power supply wirings 604 to 606. In this embodiment, portions of the electrostatic protection circuit areas 607 are positioned below the first and second power supply wirings 604 and 605. Portions of the electrostatic protection circuit areas 608 are positioned below the first and third power supply wirings 604 and 606. Each of the electrostatic protection circuit areas 607 is connected between the first and second power supply wirings 604 and 605 by means of connecting vias (i.e., in FIG. 4, the rightmost connecting via and the leftmost connecting via formed on the power supply wirings 604 and 605). Each of the electrostatic protection circuit areas 608 is connected between the second and third power supply wirings 605 and 606 by means of connecting vias (i.e., in FIG. 4, the rightmost connecting via and the leftmost connecting via formed on the power supply wirings 605 and 606).

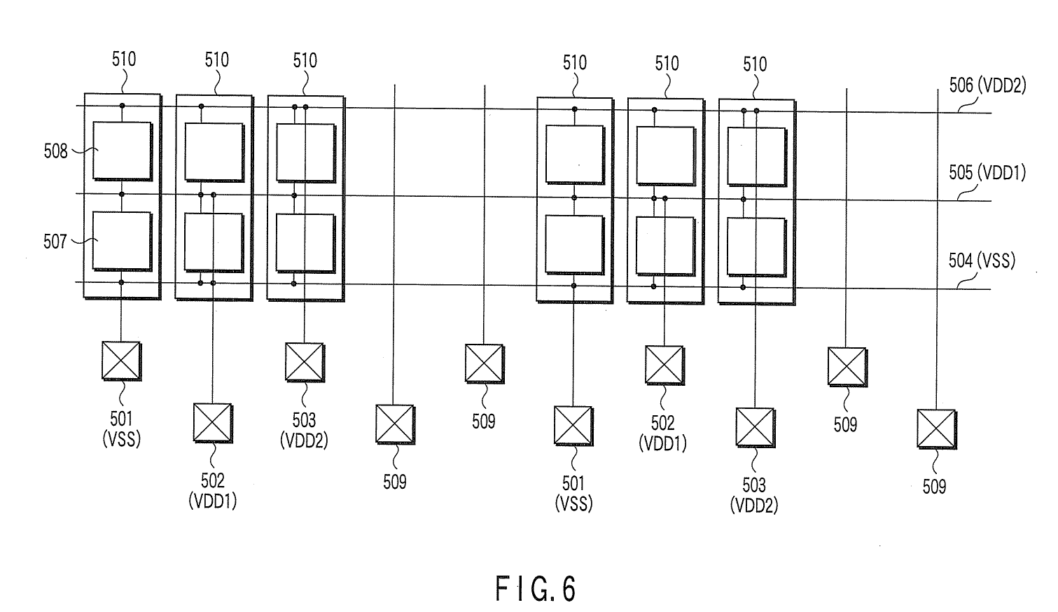

As described above, each of the electrostatic protection circuit string areas 610 in each of which one electrostatic protection circuit area 607 and one electrostatic protection circuit area 608 are connected in series to each other, is arranged to correspond to a respective one of the power supply pads 601 to 603 and functions as an electrostatic protection circuit between VDD2 and VSS. In this embodiment, the power supply pads 601 to 603 are arranged in a line. Also, the electrostatic protection circuit string areas 610 are arranged in a line. However, the power supply pads 601 to 603 may be arranged in a staggered form, for example. The overall arrangement of the power supply pads of a staggered form is shown in FIG. 6.

According to the first embodiment described above, the electrostatic protection circuit string areas 610 are provided in correspondence to the power supply pads 601 to 603, respectively, irrespective of supply voltages allocated to the power supply pads. Such arrangement of the electrostatic protection circuit string areas 610 allows electrostatic protection between each power supply voltage to be implemented. In addition, since dead space is less produced, electrostatic protection circuits can be implemented efficiently in terms of area in the peripheral area of a semiconductor chip. Further, the electrostatic protection circuit string areas 610 are uniformly arranged in a line, thus allowing the area efficiency to be further increased. Moreover, since a number of electrostatic protection circuits 507 or 508 are connected in parallel between the power supply wirings 504 and 505 or 505 and 506 as shown in FIG. 2, a circuit network can be constituted which is effective in providing electrostatic protection from large electrostatic surge currents as typified by a charged device model.

### SECOND EMBODIMENT

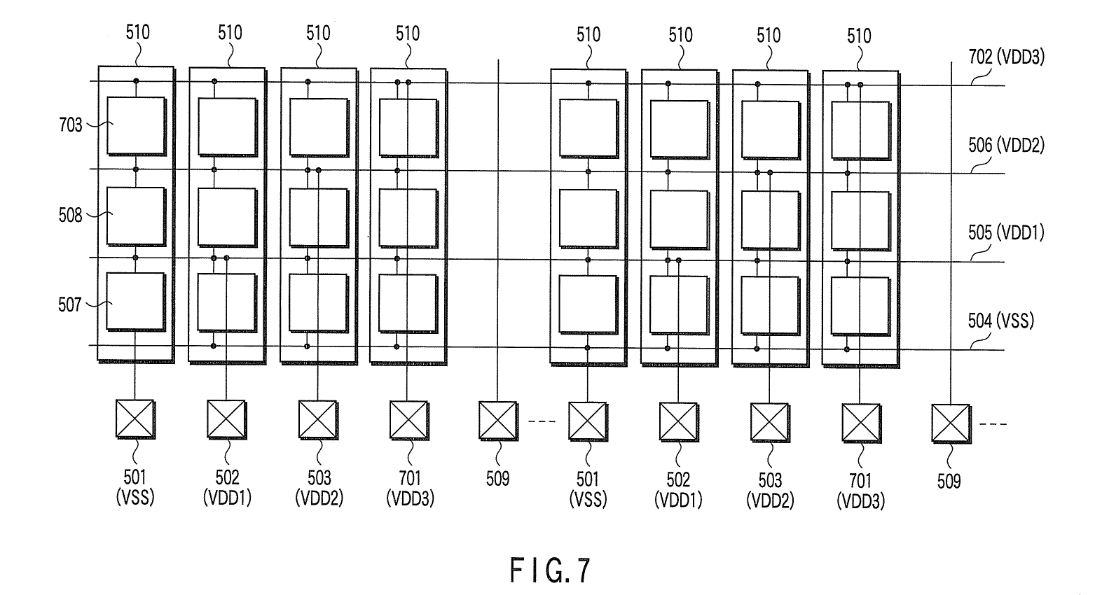

FIG. 7 shows a portion of the arrangement of power supply pads and electrostatic protection circuits formed on a peripheral area of a semiconductor chip of a logic LSI which is a semiconductor device according to a second embodiment of the present invention.

In the second embodiment as shown in FIG. 7, fourth power supply pads 701 (in FIG. 7, two fourth power supply pads) to which a fourth power supply wiring 702 is connected, is provided, in addition to the circuit arrangement of the first embodiment shown in FIG. 2. A power supply voltage VDD3 higher than VDD2 is applied to the fourth power supply pads 701. The fourth power supply pads 701 are arranged in line with the power supply pads 501, 502 and 503. Like the first embodiment, also in this embodiment, electrostatic protection circuits are provided for the fourth power supply pads 701, and thus the same advantages as those of the first embodiment are attained.

In addition, in this embodiment, each of the electrostatic protection circuit series 510 further comprises a third electrostatic protection circuit 703 connected between the third power supply wiring 506 and the fourth power supply wiring 702. The third electrostatic protection circuit 703 is connected in series to the first electrostatic protection circuit 507 and the second electrostatic protection circuit 508.

In addition to the advantages of the first embodiment, the second embodiment can provide electrostatic protection for a multi-power supply semiconductor chip which uses three or more different supply voltages.

[Specific Examples of Electrostatic Protection Circuits]

FIG. 8 shows an example of the circuit arrangement of the electrostatic protection circuits 507 and 508 shown in FIG. 2.

The electrostatic protection circuits 507 and 508 have the same circuit structure. Each of the electrostatic protection circuits 507 and 508 comprises a first path and a second path connected in parallel to each other between the corresponding two power supply wirings. Each of the first path and the second path comprises a diode string 40 composed of a number of diodes D connected in series. The diode string 40 may consist of one diode. The first path allows an electrostatic surge to discharge from one of the corresponding two power supply pads, applied in operation with a potential to the other of the corresponding two power supply pads, applied in operation with a potential lower than the potential applied in operation to said one power supply pad. The second path allows an electrostatic surge to discharge from one of the corresponding two power supply pads, applied in operation with a potential to the other of the corresponding two power supply pads, which is applied in operation with a potential higher than the potential applied in operation to said one power supply pad. The number of the diodes D in the diode string 40 in each of the first and second paths is set so that the forward bias voltage generated across each diode becomes less than 0.6 V when the highest voltage is applied between the power supply pads 501 and 502, in other words, a leakage current caused by the electrostatic protection circuit in operation is regarded as being negligible (leakage current can be suppressed).

In, for Example, the first path of the first electrostatic protection circuits 507, an electrostatic surge is discharged through the diode string 40 from the second power supply pad 502 applied in operation with a potential VDD1 to the first power supply pad 501 applied in operation with a potential VSS lower than the potential VDD1 applied in operation to the second power supply pad 502. In the second path of the electrostatic protection circuits 507, an electrostatic surge is discharged through the diode string 40 from the first power supply pad 501 applied in operation with a potential VSS to the second power supply pad 502 applied in operation with a potential VDD1 higher than the potential VSS applied in operation to the first power supply pad 501. Substantially the same is applied to the second electrostatic protection circuits 508.

The electrostatic protection circuit as described above is simple in construction and small in area, thus allowing electrostatic protection circuit series to be implemented efficiently in terms of area.

The diode string 40 used in the first path of each of the electrostatic protection circuits may be replaced with MOSFETs, bipolar transistors, or thyristors. In other words, the diode string 40 used in the path in which an electrostatic surge is discharged through the diode string 40 from one power supply pad applied in operation with a potential to another power supply pad applied in operation with a potential lower than the potential applied in operation to the one power supply pad, may be replaced with MOSFETs, bipolar transistors, or thyristors. Such an electrostatic protection circuit can suppress an excess voltage which will appear between power supply pads when an electrostatic surge current is discharged through the use of snapback operation in comparison with the case where the diode string 40 used in the first path of each electrostatic protection circuit may be replaced with MOSFETs, bipolar transistors, or thyristors.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A semiconductor device comprising:
a first power supply pad which is arranged in a peripheral area of a semiconductor chip;
a second power supply pad which is arranged in the peripheral area of the semiconductor chip and applied in operation with a potential higher than a potential applied in operation to the first power supply pad;
a third power supply pad which is arranged in the peripheral area of the semiconductor chip and applied in operation with a potential higher than the potential applied in operation to the second power supply pad;
a first power supply wiring which is arranged in the peripheral area of the semiconductor chip and electrically connected to the first power supply pad;
a second power supply wiring which is arranged in the peripheral area of the semiconductor chip and electrically connected to the second power supply pad;
a third power supply wiring which is arranged in the peripheral area of the semiconductor chip and electrically connected to the third power supply pad;
a plurality of first electrostatic protection circuits which are arranged in the peripheral area of the semiconductor chip and connected between the first and second power supply wirings, the first electrostatic protection circuits being provided in correspondence to the first, second and third power supply pads in one-to-one relationship; and
a plurality of second electrostatic protection circuits which are arranged in the peripheral area of the semiconductor chip and connected between the second and third power supply wirings, the second electrostatic protection circuits being provided in correspondence to the first, second and third power supply pads in one-to-one relationship, and the second electrostatic protection circuits and the first electrostatic protection circuits forming electrostatic protection circuit series in correspondence to the first, second and third power supply pads in one-to-one relationship.

2. A semiconductor device according to claim 1, wherein a plurality of the first power supply pads are arranged in the peripheral area of the semiconductor chip, the first power supply wiring is connected to the first power supply pads in common, a plurality of the second power supply pads are arranged in the peripheral area of the semiconductor chip, the second power supply wiring is connected to the second power supply pads in common, a plurality of the third power supply pads are arranged in the peripheral area of the semiconductor chip, and the third power supply wiring is connected to the third power supply pads in common.

3. A semiconductor device according to claim 1, wherein each of the electrostatic protection circuits comprises a first path and a second path connected in parallel to each other between the corresponding two power supply wirings, the first path allowing an electrostatic surge to discharge from one of the corresponding two power supply pads, applied in operation with a potential to the other of the corresponding two power supply pads, applied in operation with a potential lower than the potential applied in operation to said one power supply pad, the second path allowing an electrostatic surge to discharge from one of the corresponding two power supply pads, applied in operation with a potential to the other of the corresponding two power supply pads, which is applied in operation with a potential higher than the potential applied in operation to said one power supply pad, and at least one of the first path and the second path being comprised of a diode string in which a diode or a plurality of diodes is connected in series.

4. A semiconductor device according to claim 3, wherein the number of diodes in the diode string is set so that, when a maximum potential difference is generated between the corresponding power supply pads between which the diode string is connected, no leakage current is substantially generated due to the corresponding electrostatic protection circuit in operation.

5. A semiconductor device according to claim 3, wherein the number of diodes in the diode string is set so that, when a maximum potential difference is generated between the corresponding power supply pads between which the diode string is connected, a forward bias voltage generated across each of the diodes is lower than 0.6 V.

6. A semiconductor device according to claim 3, wherein the first path of each of the electrostatic protection circuits is constructed from MOSFETs, bipolar transistors, or thyristors.

7. A semiconductor device according to claim 1, further comprising:
a fourth power supply pad which is arranged in the peripheral area of the semiconductor chip and applied in operation with a potential higher than the potential applied in operation to the third power supply pad;
a fourth power supply wiring which is arranged in the peripheral area of the semiconductor chip and electrically connected to the fourth power supply pad; and
a further first electrostatic protection circuit which is arranged in the peripheral area of the semiconductor chip and connected between the first and second power supply wirings, a further second electrostatic protection circuit which is arranged in the peripheral area of the semiconductor chip and connected between the second and third power supply wirings, and a third electrostatic protection circuit which is arranged in the peripheral area of the semiconductor chip and connected between the third and fourth power supply wirings, the further first electrostatic protection circuit, the further second electrostatic protection circuit and the third electrostatic protection circuit forming a further electrostatic protection circuit series in correspondence to the fourth power supply pads, wherein
each of the electrostatic protection circuit series in correspondence to the first, second and third power supply pads further comprises a further third electrostatic protection circuit connected in series to the first and second electrostatic protection circuits.

8. A semiconductor device according to claim 7, wherein a plurality of the first power supply pads are arranged in the peripheral area of the semiconductor chip, the first power supply wiring is connected to the first power supply pads in common, a plurality of the second power supply pads are arranged in the peripheral area of the semiconductor chip, the second power supply wiring is connected to the second power supply pads in common, a plurality of the third power supply pads are arranged in the peripheral area of the semiconductor chip, the third power supply wiring is connected to the third power supply pads in common, a plurality of the fourth power supply pads are arranged in the peripheral area of the semiconductor chip, and the fourth power supply wiring is connected to the fourth power supply pads in common.

9. A semiconductor device comprising:
a plurality of power supply pads which are arranged in a peripheral area of a semiconductor chip and applied with different power supply potentials in operation;
a plurality of power supply wirings which are arranged in the peripheral area of the semiconductor chip and electrically connected to the plurality of power supply pads, respectively; and
a plurality of electrostatic protection circuits which are arranged in the peripheral area of the semiconductor chip and connected between the plurality of power supply wirings, those of the plurality of electrostatic protection circuits, which are connected in series to each other and provided in correspondence to each of the plurality of power supply pads, forming an electrostatic protection circuit series.

10. A semiconductor device according to claim 9, wherein the plurality of power supply pads comprise at least a plurality of power supply pads applied with a same power supply potential, the plurality of power supply pads applied with a same power supply potential being connected to the corresponding one or plurality of power supply wirings in common.

11. A semiconductor device according to claim 9, wherein each of the electrostatic protection circuits comprises a first path and a second path connected in parallel to each other between the corresponding two power supply wirings, the first path allowing an electrostatic surge to discharge from one of the corresponding two power supply pads, applied in operation with a potential to the other of the corresponding two power supply pads, applied in operation with a potential lower than the potential applied in operation to said one power supply pad, the second path allowing an electrostatic surge to discharge from one of the corresponding two power supply pads, applied in operation with a potential to the other of the corresponding two power supply pads, which is applied in operation with a potential higher than the potential applied in operation to said one power supply pad, and at least one of the first path and the second path being comprised of a diode string in which a diode or a plurality of diodes is connected in series.

12. A semiconductor device according to claim 11, wherein the number of diodes in the diode string is set so that, when a maximum potential difference is generated between the corresponding power supply pads between which the diode string is connected, no leakage current is substantially generated due to the corresponding electrostatic protection circuit in operation.

13. A semiconductor device according to claim 11, wherein the number of diodes in the diode string is set so that, when a maximum potential difference is generated between the corresponding power supply pads between which the diode string is connected, a forward bias voltage generated across each of the diodes is lower than 0.6 V.

14. A semiconductor device according to claim 11, wherein the first path of each of the electrostatic protection circuits is constructed from MOSFETs, bipolar transistors, or thyristors.

15. A semiconductor device comprising:
a semiconductor chip including an internal area and a peripheral area, at least an internal circuit to be protected from an electrostatic surge being formed in the internal area;
a plurality of power supply pads which are arranged in the peripheral area of the semiconductor chip and applied with different power supply potentials in operation;
a plurality of power supply wirings which are arranged in the peripheral area of the semiconductor chip and electrically connected to the plurality of power supply pads, respectively; and
a plurality of electrostatic protection circuits which are arranged in the peripheral area of the semiconductor chip and connected between the plurality of power supply wirings, those of the plurality of electrostatic protection circuits, which are connected in series to each other and provided in correspondence to each of the plurality of power supply pads, forming an electrostatic protection circuit series.

16. A semiconductor device according to claim 15, wherein each of the electrostatic protection circuits comprises a first path and a second path connected in parallel to each other between the corresponding two power supply wirings, the first path allowing an electrostatic surge to discharge from one of the corresponding two power supply pads, applied in operation with a potential to the other of the corresponding two power supply pads, applied in operation with a potential lower than the potential applied in operation to said one power supply pad, the second path allowing an electrostatic surge to discharge from one of the corresponding two power supply pads, applied in operation with a potential to the other of the corresponding two power supply pads, which is applied in operation with a potential higher than the potential applied in operation to said one power supply pad, and at least one of the first path and the second path being comprised of a diode string in which a diode or a plurality of diodes is connected in series.

17. A semiconductor device according to claim 16, wherein the first path of each of the electrostatic protection circuits is constructed from MOSFETs, bipolar transistors, or thyristors.

18. A semiconductor device according to claim 15, wherein a plurality of the electrostatic protection circuit series formed of the plurality of electrostatic protection circuits are arranged in a line along a direction in which the plurality of power supply wirings extend.

19. A semiconductor device according to claim 15, wherein the plurality of power supply pads are arranged in a line along a direction in which the plurality of electrostatic protection circuit series are arranged.

20. A semiconductor device according to claim 15, wherein the plurality of power supply pads are arranged in a staggered form along a direction in which the plurality of electrostatic protection circuit series are arranged.
